(19) United States
(12) Patent Application Publication
(10) Pub. No.: US 2015/0313438 A1
(43) Pub. Date: Nov. 5, 2015

(54) Auxiliary Oval Wheel for Robotic Devices

(71) Applicant: Ali Ebrahimi Afrouzi, San Jose, CA (US)

(72) Inventor: Ali Ebrahimi Afrouzi, San Jose, CA (US)

(73) Assignee: BOBSWEEP INC., Toronto (CA)

(21) Appl. No.: 14/701,901

(22) Filed: May 1, 2015

Related U.S. Application Data
(60) Provisional application No. 61/988,187, filed on May 3, 2014.

(51) Int. Cl. A47L 11/40

(52) U.S. Cl. CPC A47L 11/4061; A47L 11/4072; A47L 11/4011; A47L 2201/04

(57) ABSTRACT

A method for an automated robotic wheeled device to overcome small obstacles, such as flooring thresholds, comprising a set of auxiliary ellipsoid or oval wheels that are engaged when the device detects that it is obstructed from moving forward. When the oval wheels are engaged, they turn and propel the device forward and upward so that it can effectively move over obstacles that would normally be too tall for the device to overcome.

### CROSS-REFERENCE TO RELATED APPLICATIONS

This application claims the benefit of provisional patent application Ser. No. 61/988,187, filed May 3, 2014 by the present inventor.

### FIELD OF THE INVENTION

This invention is related to automated robotic wheeled devices, such as robotic vacuums, floor cleaners and floor scrubbers, robotic lawn mowers, robotic floor polishers, etc.

### BACKGROUND OF INVENTION

The following is a tabulation of some prior art that presently appears relevant:

U.S. Patent Documents

| Patent | Kind | | |
|---|---|---|---|
| Number | Code | Issue Date | Patentee |
| 8,121,730 | B2 | Feb. 21, 2012 | Industrial Technology |
| | | | Research Institute |
| 5,652,489 | A | Jul. 29, 1997 | Minolta Co., Ltd. |
| 5,293,955 | A | Mar. 15, 1994 | Goldstar Co., Ltd. |
| 7,173,391 | B2 | Feb. 06, 2007 | Irobot Corporation |
| 6,594,844 | B2 | Jul. 22, 2003 | Irobot Corporation |

Foreign Patent Documents

| Foreign Doc. | Country | Kind | | Applicant or |
|---|---|---|---|---|
| Number | Code | Code | Pub. Date | Patentee |
| 2,677,386 | EP | A1 | Dec. 25, 2013 | LG Electronics Inc. |

Various types of automated robotic devices are used in home and commercial settings to carry out routine tasks like vacuuming, mopping, and polishing floors. These and similar devices usually have to move from one floor type to another in order to complete jobs. Frequently, changes in flooring are accompanied by small elevation changes or thresholds. In some cases, thresholds, bumps, or other elevation changes may be too tall for the device to move across. In the case of an automated robotic vacuum, this problem could result in the device getting stuck on a threshold and not finishing the job or requiring human intervention to move over the obstacle.

Although prior art has provided several methods for autonomous robotic devices to avoid obstacles, causing a robotic vacuum to avoid threshold transitions and other small elevation changes altogether would limit the cleanable area to only substantially flat workspaces. Because thresholds and small elevation changes are unavoidable in many homes, a need exists for a method to aid automated robotic devices in crossing such elevation changes.

U.S. Pat. No. 6,594,844 (iRobot Corp.) provides a means to detect and avoid different obstacle types with an optical emitter, however, this solution offers no method to help an automated robotic device travel across a change in elevation or release the device in the event that it gets stuck.

One solution is to increase the wheel size of an automated robotic device to provide more space between the bottom of the chassis and the surface on which the device is traveling. However, this solution increases the overall height of the device, which may introduce new problems, such as getting stuck under furniture or not being able to enter beneath as many pieces of furniture. A need exists for a method to improve an automated robotic wheeled device's ability to overcome obstacles that does not limit its mobility.

### SUMMARY

It is a goal of the present invention to provide a method for a wheeled device to overcome changes in elevation, such as flooring transitions.

It is a goal of the present invention to provide a solution that does not reduce the effectiveness of an automated robotic device that services an area.

It is a goal of the present invention to reduce the amount of human intervention needed to operate an automated robotic device that services an area.

It is a goal of the present invention to increase the autonomy of automated robotic devices.

The present invention achieves the aforementioned goals through a set of oval-shaped auxiliary wheels installed on an automated robotic wheeled device that is activated whenever the device detects that it has become stuck. When activated, the auxiliary wheels turn and propel the device forward and upward, helping it move over small changes in elevation, such as flooring transitions that are commonly found in homes.

Such a system could be useful in robotic vacuums that frequently encounter raised thresholds and other obstacles while traveling in homes. In one embodiment, the system can be paired with a brush vibrator and reverse brush spin mechanism, so that when a robotic vacuum detects that it has become stuck, it simultaneously engages its oval wheels, vibrates its brush, and spins its brush backward to release and untangle any potentially caught debris. This system would be an effective method for untangling a robotic vacuum from cords, cables or strings that are commonly found on floors in homes.

### BRIEF DESCRIPTION OF THE DRAWINGS

FIG. 1A shows the difference between an ellipsoid wheel and a standard wheel.

FIG. 1B shows a three-dimensional view of an ellipsoid wheel.

FIG. 1C shows an ellipsoid wheel in an initial starting position with its elongated side pointing up.

FIG. 1D shows an ellipsoid wheel in a position after initiating movement with its elongated side turning toward the surface upon which the wheel is turning.

FIG. 1E shows an ellipsoid wheel in a position after initiating movement with its elongated side in contact with the surface upon which the wheel is turning, causing the point about which the wheel pivots to be elevated.

FIG. 2A shows a front view of an elliptical cylinder auxiliary wheel.

FIG. 2B shows a perspective view of an elliptical cylinder auxiliary wheel.

FIG. 3A shows an overhead view of the underside of a robotic vacuum provided with the described auxiliary wheel system.

FIG. 3B shows a left side elevation view of a robotic vacuum provided with the described auxiliary wheel system.

FIG. 4 shows a side view of a robotic vacuum using the proposed method to travel over an obstacle.

### DETAILED DESCRIPTION OF THE INVENTION

Although the following disclosure relates to robotic vacuums, the invention hereof is not limited to such devices and may be useful in other devices or systems wherein one or more of the design criteria listed above are important.

The present invention proposes a method for automated robotic wheeled devices to overcome obstacles. In particular, the proposed invention seeks to assist automated robotic wheeled devices in crossing thresholds or other relatively small vertical elevation changes. A set of auxiliary wheels in the form of ellipsoids or elliptical cylinders are proposed to propel the device upward and over such obstacles.

According to the present invention, an automated robotic wheeled device, such as a robotic vacuum, is equipped with a set of auxiliary wheels in the shape of ellipsoids or elliptic cylinders. One or more electric motors or servomotors are used as a means to turn the auxiliary wheels.

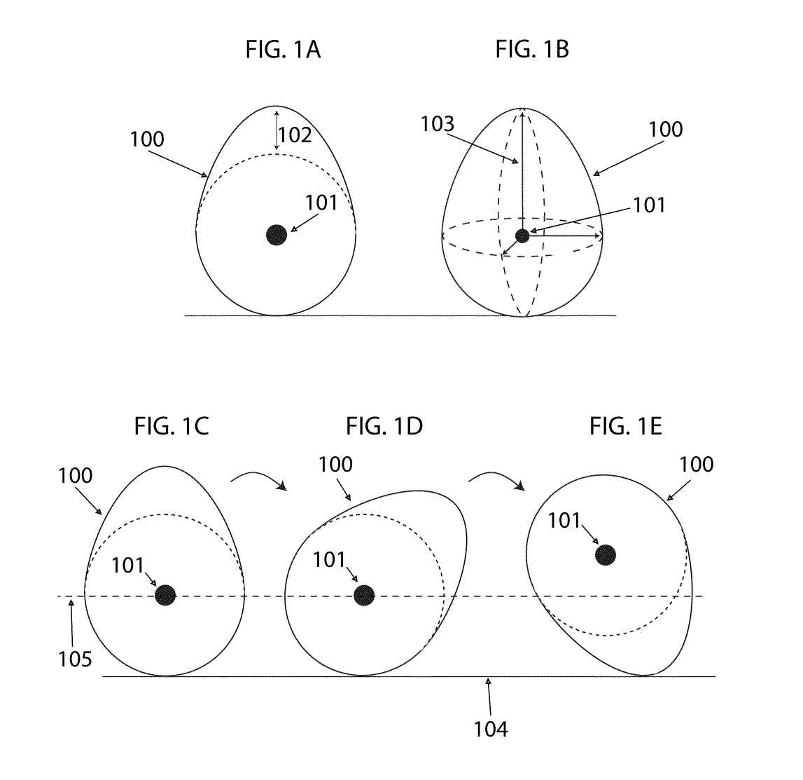

As shown in the two-dimensional view FIG. 1A and the three-dimensional view FIG. 1B, an ellipsoid wheel 100 is created by extending at least one side of a conventional wheel from its center point 101. The amount of this extension 102 determines the additional amount that the apparatus to which the wheels are attached will be propelled upward when the elongated axis 103 is perpendicular and adjacent to the floor or other surface on which the apparatus is driving. FIGS. 1C, 1D, and 1E demonstrate the movement of such a wheel about the pivot point 101 where it would be connected to an apparatus. FIG. 1C shows the wheel 100 in an initial starting position. FIG. 1D shows the wheel 100 in a later position, rotated slightly. FIG. 1E shows the wheel 100 in a later position, rotated further. The distance from the surface upon which the apparatus is traveling 104 to the pivot point 101 remains constant, as demonstrated by the line 105 until the extended portion of the wheel comes into contact with the surface. At such a time, this distance is temporarily increased, as depicted by FIG. 1E, allowing an apparatus to move over obstacles that would normally be too high to cross. As the wheel continues turning, the extended portion of the wheel rotates off of the surface and the distance between the surface and the pivot point returns to normal.

Depending on the application of the auxiliary wheel and other parameters, the suitable value of the extension 102 can be pre-calculated for the particular needs of the situation.

In the preferred embodiment, a set of gears is used as a means to engage and disengage the auxiliary wheels. In their engaged position, the auxiliary wheels function as described above. In their disengaged position, the auxiliary wheels do not make contact with the surface on which the automated robotic device is driving and thus have substantially no effect on the device's movement. Thus, a robotic vacuum or other similar device operates as normally when the auxiliary wheels are disengaged.

In the preferred embodiment, the automated robotic wheeled device is further equipped with a means to sense when its forward movement is hampered, such condition causing the auxiliary wheels to be engaged. Any available means for detecting that forward movement is hampered, such as resistance sensors, light tracking mechanisms, or any other method could be used.

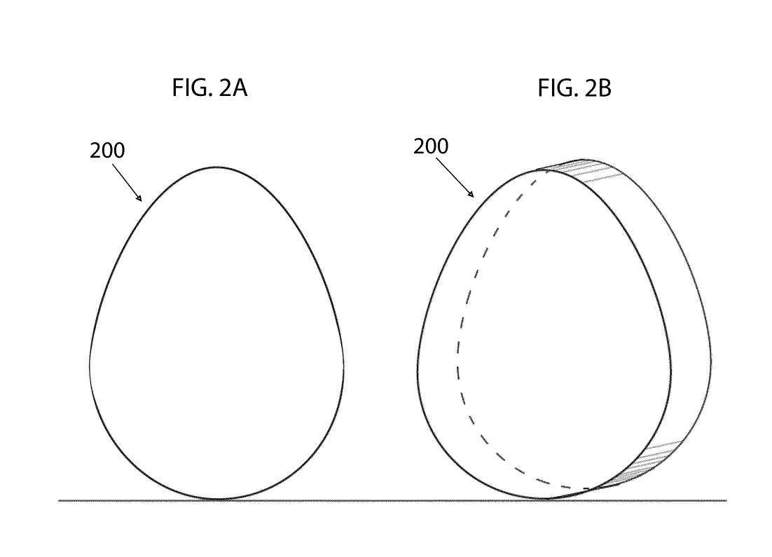

FIGS. 2A and 2B show an alternate elliptical cylinder shape for an auxiliary wheel. FIG. 2A shows a two-dimensional view of an elliptical cylinder auxiliary wheel 200. FIG. 2B shows a perspective view of the elliptical cylinder auxiliary wheel 200. In this form, the wheel has flat elliptical sides. An auxiliary wheel in this form operates in the same manner as an ellipsoid wheel, so a description of the movement thereof is not repeated herein.

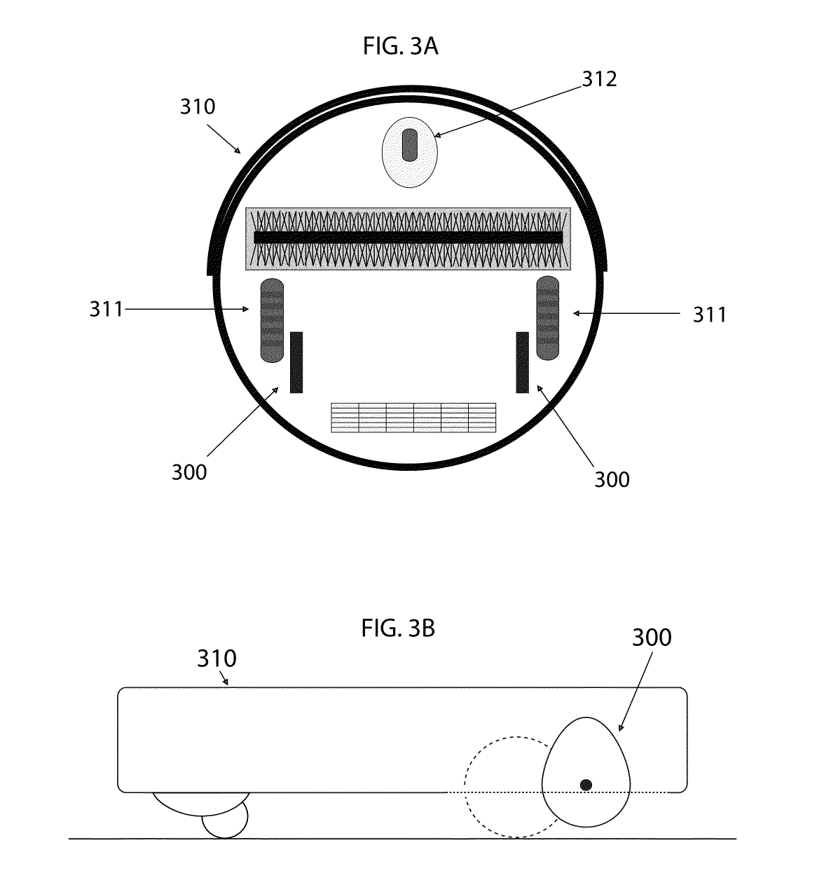

FIG. 3A shows an overhead view of the underside of a robotic vacuum 310 equipped with the described system. The vacuum has ordinary wheels 311 for forward movement and a turning wheel 312. The vacuum also has auxiliary wheels 300.

FIG. 3B shows a side view of the same robotic vacuum 310. The auxiliary wheels 300 are in their disengaged position, within the body of the vacuum.

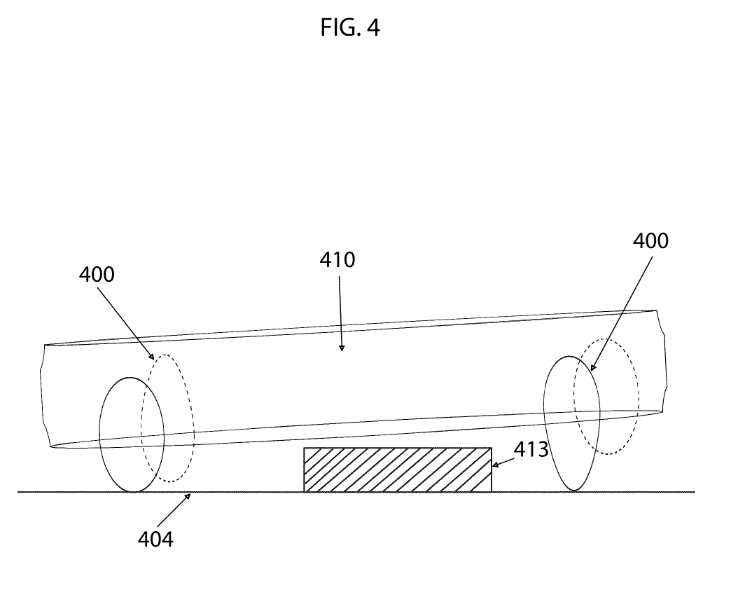

FIG. 4 shows a perspective view of the robotic vacuum 410 engaging the auxiliary wheels 400 to overcome the obstacle 413. When the extended portion of the auxiliary wheel is in contact with the floor 404, the distance between the bottom of the chassis of the device and the floor is increased, allowing the device to move over the obstacle 413 without getting stuck.

In some embodiments, the auxiliary wheels are engaged for a predetermined length of time or number of wheel rotations.

In some embodiments, the auxiliary wheels are engaged only for as long as the automated robotic wheeled device senses that its forward movement is hampered.

In some embodiments, the auxiliary wheels are turned in succession, one after the other.

In some embodiments, the auxiliary wheels are turned simultaneously.

In some embodiments, the surface of auxiliary wheels is textured to increase traction.

In some embodiments, the auxiliary wheels are covered with a layer of high-friction material to increase traction.

In some embodiments, the method for overcoming obstacles further comprises rotating a main brush of the automated robotic wheeled device in a reverse direction from the normal rotation of said main brush. In a robotic vacuum, for example, detection of a hampering in forward movement also triggers a mechanism to rotate a main brush of the device in reverse while engaging the auxiliary wheels to assist in disentangling the device from any potentially trapped debris, which is another form of obstacle encountered by automated robotic wheeled devices. Any available means may be used to rotate said main brush in a reverse direction, such as a motor or a set of gears.

In some embodiments, the method for overcoming obstacles further comprises vibrating a main brush of the automated robotic wheeled device. In a robotic vacuum, for example, detection of a hampering in forward movement also triggers a mechanism to vibrate a main brush while engaging the auxiliary wheels to assist in disentangling the device from any potentially trapped debris. Any available means may be used to vibrate said main brush, such as a motor or a set of gears.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

We claim:

1. A method to aid an automated robotic wheeled device in overcoming obstacles comprising:
a. one or more auxiliary wheels in the form of ellipsoids or elliptical cylinders, and
b. a means to turn said auxiliary wheels,
whereby said automated robotic wheeled device is propelled upward by the turning of said auxiliary wheels, allowing said automated robotic wheeled device to drive over certain obstacles.

2. The method of claim 1 in which the method further comprises a means to engage and disengage said auxiliary wheels such that in their disengaged position, said auxiliary wheels do not make contact with the surface on which said automated robotic wheeled device is driving and in their engaged position, said auxiliary wheels do make contact with the surface on which said automated robotic wheeled device is driving.

3. The method of claim 2 in which the method further comprises a means for said automated robotic wheeled device to detect conditions in which its forward movement is hampered, such condition causing said auxiliary wheels to be engaged.

4. The method of claim 3 in which said auxiliary wheels are disengaged after a predetermined number of wheel rotations, or after a predetermined amount of time, or when it is detected that forward movement of said automated robotic wheeled device is no longer hampered.

5. The method of claim 1 in which said means to turn said auxiliary wheels turns said auxiliary wheels in succession, one after the other.

6. The method of claim 1 in which said means to turn said auxiliary wheels turns said auxiliary wheels simultaneously.

7. The method of claim 1 in which said auxiliary wheels are textured or covered with a high-friction material to increase traction.

8. The method of claim 3 in which the method further comprises a means for rotating a main brush of said automated robotic wheeled device in a reverse direction from the normal rotation of said main brush to assist in freeing said automated robotic wheeled device from potential entanglements, and wherein, upon detecting a condition in which forward movement of said automated robotic wheeled device is hampered, said main brush rotates in said reverse direction.

9. The method of claim 3 in which the method further comprises a means to vibrate a main brush of said automated robotic wheeled device to assist in freeing said automated robotic wheeled device from potential entanglements, and wherein, upon detecting a condition in which forward movement of said automated robotic wheeled device is hampered, said main brush vibrates.

10. The method of claim 8 in which the method further comprises a means to vibrate a main brush of said automated robotic wheeled device to assist in freeing said automated robotic wheeled device from potential entanglements, and wherein, upon detecting a condition in which forward movement of said automated robotic wheeled device is hampered, said main brush vibrates.

11. One or a set of auxiliary wheels in the form of ellipsoids or elliptical cylinders to aid an automated robotic wheeled device in overcoming obstacles whereby said automated robotic wheeled device is propelled upward by the turning of said auxiliary wheels, allowing said automated robotic wheeled device to drive over certain obstacles.

12. The auxiliary wheels of claim 11 in which said automated robotic device is further equipped with a means to engage and disengage said auxiliary wheels such that in their disengaged position, said auxiliary wheels do not make contact with the surface on which said automated robotic wheeled device is driving and in their engaged position, said auxiliary wheels do make contact with the surface on which said automated robotic wheeled device is driving.

13. The auxiliary wheels of claim 11 in which said automated robotic device is further equipped with a means for said automated robotic wheeled device to detect conditions in which its forward movement is hampered, such condition causing said auxiliary wheels to be engaged.

14. The auxiliary wheels of claim 13 in which said auxiliary wheels are disengaged after a predetermined number of wheel rotations, or after a predetermined amount of time, or when it is detected that forward movement of said automated robotic wheeled device is no longer hampered.

15. The auxiliary wheels of claim 11 in which said auxiliary wheels turn in succession, one after the other.

16. The auxiliary wheels of claim 11 in which said auxiliary wheels turn simultaneously.

17. The auxiliary wheels of claim 11 in which said auxiliary wheels are textured or covered with a high-friction material to increase traction.

18. A method to aid an automated robotic vacuum in overcoming obstacles comprising:
a. one or more auxiliary wheels in the form of ellipsoids or elliptical cylinders, and
b. a means to turn said auxiliary wheels,
whereby said automated robotic vacuum is propelled upward by the turning of said auxiliary wheels, allowing said automated robotic vacuum to drive over certain obstacles.

19. The method of claim 18 in which the method further comprises a means to engage and disengage said auxiliary wheels such that in their disengaged position, said auxiliary wheels do not make contact with the surface on which said automated robotic vacuum is driving and in their engaged position, said auxiliary wheels do make contact with the surface on which said automated robotic vacuum is driving.

20. The method of claim 19 in which the method further comprises a means for said automated robotic vacuum to detect conditions in which its forward movement is hampered, such condition causing said auxiliary wheels to be engaged.

21. The method of claim 20 in which said auxiliary wheels are disengaged after a predetermined number of auxiliary wheel rotations, or after a predetermined amount of time, or when it is detected that forward movement of said automated robotic vacuum is no longer hampered.

22. The method of claim 18 in which said auxiliary wheels are textured or covered with a high-friction material to increase traction.

23. The method of claim 20 in which the method further comprises a means for rotating a main brush of said automated robotic vacuum in a reverse direction from the normal rotation of said main brush to assist in freeing said automated robotic vacuum from potential entanglements, and wherein, upon detecting a condition in which forward movement of said automated robotic vacuum is hampered, said main brush rotates in said reverse direction.

24. The method of claim 20 in which the method further comprises a means to vibrate a main brush of said automated robotic vacuum to assist in freeing said automated robotic vacuum from potential entanglements, and wherein, upon detecting a condition in which forward movement of said automated robotic vacuum is hampered, said main brush vibrates.
